(19) United States
(12) Patent Application Publication
(10) Pub. No.: US 2023/0406494 A1
(43) Pub. Date: Dec. 21, 2023

(54) A KITE

(71) Applicant: OCEANERGY INNOVATION GMBH, Stuttgart (DE)

(72) Inventors: Wolfram Johannes Bernd REINERS, Sunset Beach (ZA); Armin HARICH, Berlin (DE)

(73) Assignee: OCEANERGY INNOVATION GMBH, Stuttgart (DE)

(21) Appl. No.: 18/031,019

(22) PCT Filed: Oct. 11, 2021
(86) PCT No.: PCT/ZA2021/050057

§ 371 Date: Apr. 10, 2023

(30) Foreign Application Priority Data
Oct. 9, 2020 (ZA) 2020/06272

(51) Int. Cl. B64C 31/06; B64C 39/02

(52) U.S. Cl. CPC B64C 31/06; B64C 2031/065; B64C 39/022

(57) ABSTRACT

A kite (10) which includes a canopy (12) comprising an upper sail (14) and a plurality of rib bridles (26) arranged substantially at an inclined angle relative the upper sail (14), wherein the rib bridles (26) are further connectable to upper sail bridles (32), which upper sail bridles (32) extend substantially at an inclined angle away from the rib bridles (22).

### TECHNICAL FIELD OF THE INVENTION

This invention relates to kites adapted for efficient harvesting of wind energy or energy contained in moving fluids, to drive RES (renewable energy sources). If these RES are designed to be the foundation for green hydrogen production, or for other e-fuels (electrofuels) production, or merely to produce power, the maximum amount of energy in wind or moving fluids needs to be harvested. One of the key elements to achieve this may be by utilizing a RES kite with a relatively large surface area which is configured to withstand high loads, and which is further of light weight so as to maximize the range of their operation conditions and their energy yield.

### BACKGROUND TO THE INVENTION

For the purpose of this specification the term “kite” shall mean to include a tethered wing, manufactured from textiles, fabrics, foils, laminates, sails, lines, bridles or any other similar soft or semi-rigid materials, with or without inflated structures, either self-inflating (e.g. according to the ram principle) or pre-inflated or pre-pumped, to form a wing profile or any other similar wind engagement element connected to the ground by a line or rope or cable (in summary “line”), or by a plurality of such lines/ropes/cables, and capable of being lifted aerodynamically by the wind or other moving medium or fluid during operation. The singular version “kite” shall also imply a plurality of such kites, same for the line/lines connected to the ground or ground station, fixed or movable, either on land, or on a watercraft, or an anchored buoy or platform.

The aim of a kite is typically to exert or produce a tractive force. This can for instance be for the purpose to propel a vehicle or a watercraft, or to drive a generator or a pump.

The lighter a kite, the less wind it usually requires to fly. The more load its structure can hold, the more energy it can harvest. Therefore, the inventors consider it of great advantage, if a kite is light, yet can tolerate highest load and forces on its traction ropes. High lift-to-drag-ratio for a higher energy output, and easy handling and flying in many different wind conditions is of further advantage.

Reinforcement of Kites

Known forms of kites typically consists of a canopy made out of at least one sail, usually the upper sail, and possibly one or more lower-sails, which may extend largely about parallel to the upper sail, either under a portion of the upper sail, wingspan-wise or chord-wise, or even over the full length or breadth of the upper sail, and sometimes the canopy is further made out of ribs, or also called diagonals, flares or winglets, and if present, largely arranged about perpendicular to the upper/lower-sail, pointing quite downwards, into the direction of the kite connecting line(s).

Kite connecting lines are extending from a ground station often via bridles to the kite. The bridles are the last sections, before the kite, often forked, reaching the canopy or its structures, for instance the ribs or the various sails, for instance a lower-sail or the upper sail.

Stacked kites are possible, where several kites are arranged in sequence, to form a double-decker or a multi-decker.

Bridles, where they reach the canopy, end in the so-called attachment points. Attachment reinforcements strengthen these attachment points, with the aim to hold high loads and withstand high forces, and to guide, induce and disperse the loads into the canopy structure.

Induction of Load into Sails and Distribution of Load from Sails

Known is the usage of high-strength fibers to maximize loads on sails, without adverse effects, like changes in shape or long-term stretching or breakage, or distribute the load from attachment points, for instance the clew. The load may be induced or distributed from the luff, which may be attached to a mast, by any known means, or from a rope which extends from the deck of a watercraft substantially upwards, from the sail to the mast, or vice versa. Sails may for instance be supported either via a luff bolt rope track or batten cars, which are spread evenly along the length of the luff. Loads are induced or transferred back to the watercraft via high load points, e.g. the clew, luff, foot and/or head, from which fiber or other high-load structures extend.

In these known forms, the load is induced into a sail or distributed from the area of a sail in a substantially tangential direction, e.g. towards a mast or a sheet.

For the purpose of this specification the following term and/or phrase shall, unless specifically stated otherwise, be interpreted to mean the following:
“Substantially at an inclined angle (away)” shall mean to include any angle between 30 and 90 degrees and/or 90-150 degrees.

### SUMMARY OF THE INVENTION

According to the invention there is provided a kite which includes:
a canopy comprising:
   an upper sail; and
   a plurality of rib bridles arranged substantially at an inclined angle relative the upper sail;
wherein the rib bridles are further connectable to upper sail bridles, which upper sail bridles extend substantially at an inclined angle away from the rib bridles.

The kite may further include at least one kite connecting line connectable to the rib bridles.

The canopy may be configured to have a lift-drag ratio of minimum 3.

The canopy may be configured to have a lift-drag ratio of minimum 4.

The rib bridles may include an intermediate bridle network for interconnecting the plurality of rib bridles and the kite connecting line, when in use.

The span-wise width of the canopy may measure at least double the chord length.

The kite may have a minimum of 5 ribs.

The kite may have a minimum of 5 cells.

The rib bridles and upper sail bridles may have a breaking strength index different from one another.

At least one of the upper sail bridles may have a breaking strength index less than that of at least one interconnected rib bridle.

A major portion of the upper sail bridles may have a breaking strength index less than that of the rib bridles connected thereto.

The breaking strength of the upper sail bridles and rib bridles may be adaptable according to the load distribution experienced.

A major portion of the rib bridles proximate to the upper sail may have a breaking strength index less than that of the rib bridles located proximate lower attachment points where an intermediate bridle is located.

A major portion of the rib bridles may be connected to upper sail bridles, the upper sail bridles in turn may extend at an inclined angle away from the rib-bridles.

The rib bridles and upper sail bridles may, when operated in conjunction with one another, include a means for varying the angle of attack of the kite.

At least one kite connecting line may be indirectly connected to at least one rib-bridle via a mixer.

A mixer shall mean to include a system for adjusting the angle of attack of the kite and/or to modify the geometry of the chamber of the airfoil and can be located between the kite connecting line and the intermediate bridle network.

The at least one kite connecting line may be indirectly connected to at least one rib bridle via a bow-bridle.

The at least one kite connecting line may be indirectly connected to at least one rib bridle via a gondola.

Connecting formations may be provided for interconnecting the rib bridles and the upper sail bridles.

A minimum of ten connecting formations may be provided for interconnecting the rib bridles and the upper sail bridles.

The rib bridles may terminate at the upper sail bridles, the upper sail bridles further extending wing span wise towards other ribs and/or rib bridles into opposing directions for dispersing the load.

A portion of the rib bridles may terminate in chord bridles or other specially added reinforcement formations, which in turn may extend chord wise and induce the load towards other rib bridles of the same rib layer.

The upper sail bridles may terminate in a split and/or furcated formation and may further terminate at other bridles.

The upper sail bridles may be of split and/or furcated formation.

The upper sail bridles may terminate and extend into further rib bridles.

The upper sail bridles may extend from one or more rib bridles wing span wise to one or more other rib bridles, at another rib, in a closed loop architecture.

The upper sail bridles may extend from a rib bridle at one chord towards a rib bridle at another chord substantially parallel to the axis defined between wing tips of the kite.

The upper sail bridles may extend from a rib bridle at one chord to a rib bridle at another chord non-parallel relative an axis defined between wing tips of the kite, in a so-called shoe lace style.

The rib bridles may support the ribs, the ribs may in turn be manufactured from any one or more of fabric, textiles and laminated material, or a combination thereof.

The rib bridles may emulate/mimic conventional ribs, in the absence of any fabric/textile/laminate material, and distribute the load to the upper sail bridles only by means of the rib bridles.

The at least one kite connecting line and intermediate bridle network may be attached to the rib bridles via additional pulleys, a mixer, or similar hoists.

The rib bridles may be connected to chord bridles which chord bridles extend at an inclined angle away from the rib bridles, and, at an inclined angled away from the upper sail bridles.

The rib bridles may be connected to chord bridles which chord bridles extend substantially orthogonally away from the rib bridles, and, substantially orthogonally away from the upper sail bridles.

The rib bridles may be connected to chord bridles, the chord bridles in turn extending at an angle of between 30 and 90 degrees away from the rib bridles and substantially orthogonally away from the upper sail bridles.

The at least one kite connecting line may extend from the canopy to a ground station, the ground station in turn may be ground or water based.

The canopy may be free flying, without any connection to a ground station, with the at least one kite connecting line connected to a load, instead.

The load may include any resistance and/or weight element such as a spacecraft, ship, a packet, an airplane, train wagon, base station, or the like.

The rib bridles may further be connected to lower bridles which lower bridles may be situated below the upper sail and further extending at an inclined angle away from the rib bridles.

In another form of the invention the kite may further include one or more lower sails.

The upper sail may be arranged relative the lower sail so that the upper sail at least partially overlay the lower sail.

In this form of the invention the rib bridles are connected to lower sail bridles, which extend at an inclined angle away from the rib bridles.

The invention may contain diagonal bridles, which are a specific form of rib bridles, which connect to the upper sail bridles and/or the chord bridles at an angle substantially between 35 and 55 degrees, with the aim to spread the load, from the kite connecting lines or the intermediate bridles to the upper sail, diagonally.

The lower bridles and/or lower sail bridles and/or diagonal bridles may be defined so as to absorb lateral forces between suspension lines.

The upper sail bridles may be releasably connectable to the upper sail.

The length dimension of a major portion of the upper sail bridles may exceed the length aspect of the upper sail.

The upper sail may be detachable arranged relative the upper sail bridles.

The detachable upper sail may have pinholes, through which short rib bridle connectors are guided, each connecting with at least one upper sail bridle.

The pinholes may be reinforced.

Pressure bags may be present between bridle structures.

The pressure bags may be interconnected.

The pressure bags may be pre-filled.

The pressure bags may be filled with ram air.

The pressure bag(s) may be filled with a gas lighter than air.

### BRIEF DESCRIPTION OF THE DRAWINGS

The invention will now be described by way of the following, non-limiting example with reference to the accompanying drawings.

In the drawings:—

FIG. 1 is a schematic of an embodiment of the kite;

FIG. 2 is a schematic cross section;

FIGS. 3a, 3b and 3c are cross sectional side view, chord wise, depicting several embodiments of the arrangement of rib-bridles;

FIG. 4 is a further schematic of rib bridles;

FIG. 5 depicts rib bridles and upper sail arranged to define two upper canopy sails;

FIG. 6 illustrates upper sail extending across several cells;

FIG. 7 illustrates high strength fibers of the rib bridles extending into the upper sail;

FIG. 8 illustrates a further configuration of rib bridles;

FIG. 9 illustrates the addition of further upper sail bridles;

FIG. 10 is an explosive view illustrating a kite with two canopy cells;

FIG. 11 is a schematic illustrating a further configuration of rib bridles and upper sail bridles;

FIG. 12 is a schematic illustrating a further embodiment of a kite having two canopy cells;

FIGS. 13 a, 13b and 13 c depict a further embodiment of a kite;

FIG. 14 is a schematic illustrating the support of high-strength fibers;

FIG. 15 is a schematic illustrating high strength fibers arranged along load paths;

FIG. 16 is a schematic illustrating interconnection of rib bridles and a kite connecting line;

FIG. 17 is a further schematic illustrating arrangement of rib bridles;

FIG. 18 is a schematic illustrating arrangement of upper sail bridles in detachable relationship with the upper sail;

FIGS. 19a, 19b and 19c are schematics illustrating different interconnection configurations between the different types of bridles;

FIGS. 20a, 20b, 20c, 21a, 21b, 21c, 22a, 22b, 22c, 23, 24, and 25 illustrate further configurations for interconnecting the different types of bridles;

FIGS. 26a, 26b, 26c, 26d and 26e illustrate different configurations of the type and bridles and upper sail;

FIGS. 27a, 27b, 27c and 27 d depict a further embodiment of the upper sail and different type of bridles; and

FIGS. 28 and 29 depict a further embodiment of a kite, in accordance with the invention.

### GENERAL DESCRIPTION OF THE INVENTION

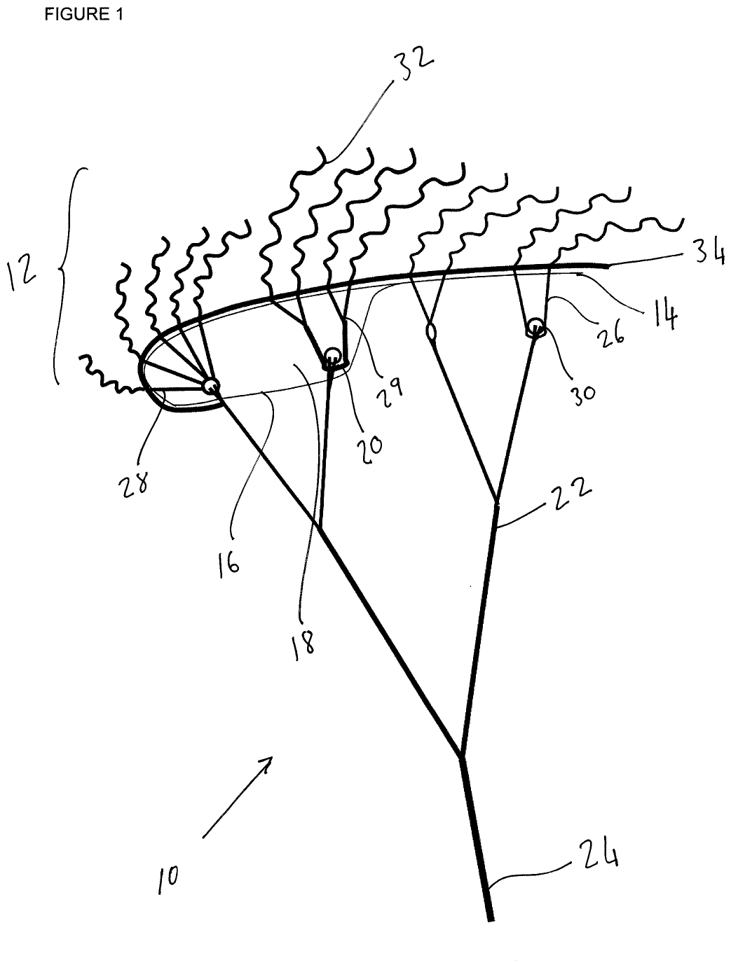

FIG. 1 shows a schematic of an embodiment of the kite 10 which includes a canopy 12 which consists of an upper sail 14 and a lower sail 16 suspended on ribs 18. Ribs 18 have attachment points 20 to connect to intermediate bridles 22 or to the kite connecting lines or ropes 24.

The ribs 18 can consist of a fabric/textile material, and can be combined with high-strength fibers, or can be composed solely of rib bridles 26, or a combination thereof.

High strength fibers absorb the load from the attachment points 20 and disperse it into the ribs 18 and into the sails 14 and 16.

The ribs 18, if present, are arranged substantially at an inclined angle (up to essentially perpendicular) to the sails 14 and 16.

The high-strength rib bridle fibers typically consist of synthetic high-strength materials, such as HMPE or UHMWPE (e.g. Dyneema, Vectran) or carbon fiber or Kevlar, or the like.

The high strength fibers can be arranged largely perpendicular to the sails 14, 16, and therefore, if present, longitudinally rib 18, thereby defining the rib bridles 26.

The rib bridles 26 in cross section can be rounded, flat like a webbing, aerodynamic profiled, or any other shape.

The load on the attachment points or connection points 20 of the rib bridles 26 is absorbed and dispersed along the ribs 18 and/or into the sails 14 and 16.

The high-strength fibers originate from the attachment points 20 and can fork/split further defining a branched out structure 28 and/or forked structure 29.

These can further be connected (sewed, glued, laminated, stitched) on a fabric material and can be arranged about a ring-like structure 30, which comprise out of high strength or high-performance material, such as carbon fiber or steel.

A group of several rib bridles 26 can be arranged longitudinally the rib 18, when present, leading up to the chord of the kite 10. The rib bridles 26 can also be connected to other bridles, like an upper sail bridle 32, a chord bridle 34 or a lower-sail bridle or lower bridle.

The rib bridles 26 can further support a rib 18, which consists of a carrier fabric or carrier material.

Downwards, the rib bridles 26 are connected to intermediate bridles 22 or to the kite connecting lines 24.

Mixers (not shown), or a special form of a mixer in the form of a bow-bridle (not shown.

A bow bridle is a line where the two ends are connected to intermediate bridles, a mixer or kite connecting lines, and where the rib bridles connect to at least three positions of the bow bridle) or other known means with the aim to adapt the lengths of the path along these bridles, measured from the origin of the kite connecting line 24 to the chord of the kite, separately or in combination with one another, can further be located between the intermediate bridles 22 and the kite connecting lines 24.

The different type of bridles can be manufactured/configured so as to have an increase in breaking strength towards from the ground station of the kite upward.

Multiple high strength fibers can originate from one attachment point 20 and can be connected with a knot or with a loop, or arranged or laid around an attachment point 20.

The bridles can fork out in different sets of sequential branches to efficiently disperse the load, into the rib direction, and if present, alongside the rib 18, towards the lower sail 16, upper sail 14 or a chord or a chord-bridle 34 of the kite 10.

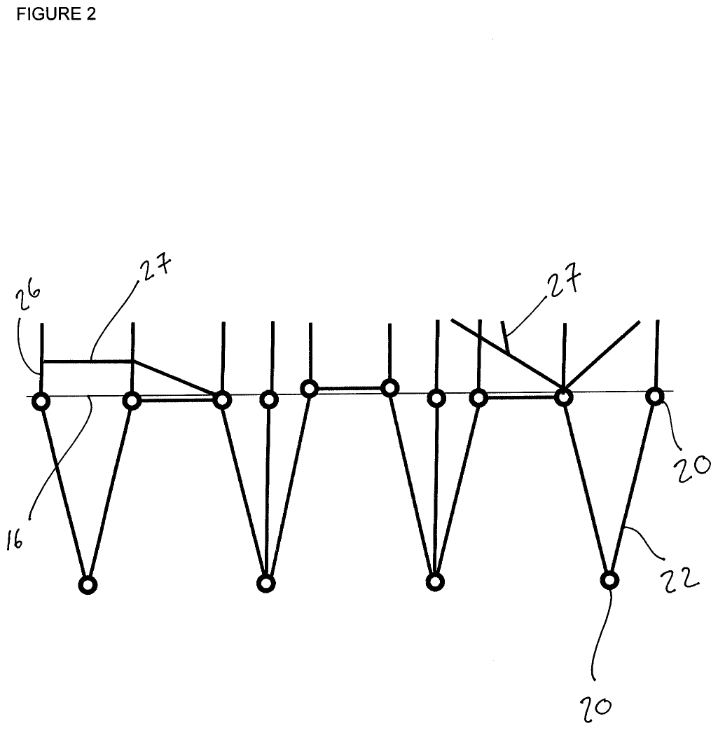

FIG. 2 is a schematic cross-sectional view of kite 10, from the leading edge to the trailing edge, or vice versa, showing multiple intermediate bridles 22 and rib-bridles 26, manufactured from high-strength fibers, originating from their attachment points 20, extend upwards towards the lower sail 16 and upper sail (not shown).

Lower sail bridles 31 absorb the lateral forces, and reinforce the lower sail 16 inducing, or, absorbing also lateral forces into the lower sail 16. The lower sail bridles 31 can be located above and/or underneath the lower sail 16.

In addition, if a lower sail is present (or partly present at this section of the canopy), the additional function of the lower sail bridle in conjunction with the rib bridles 26 will be to withstand and absorb the dynamic ram pressure, as built up between upper sail 14 and lower sail 16.

In the absence of a lower sail 16, lower sail bridles 31, diagonal bridles 27 or upper sail bridles (not shown) can serve the function to absorb lateral forces.

The rib bridles 26 absorb the load from the upper sail (not shown), connected to either chord-bridles (not shown) and/or upper sail bridles (not shown), or both.

Rib bridles 26 can also be arranged diagonally to define diagonal bridles 27, from an attachment point 20 to the lower sail 16, or the attachment point 20 at the lower sail 16 to an upper sail bridle 32.

These diagonal rib bridles 27 (diagonal in wing-span direction or in front-back direction or a mixture) can further be furcated to reduce the number of attachment points 20, and/or rib-bridles 26, and/or intermediate bridles 22, and/or other bridles, and/or the overall length of the rib bridles or intermediate bridles, and/or to improve the aerodynamics of the kite 10, and therefore its performance.

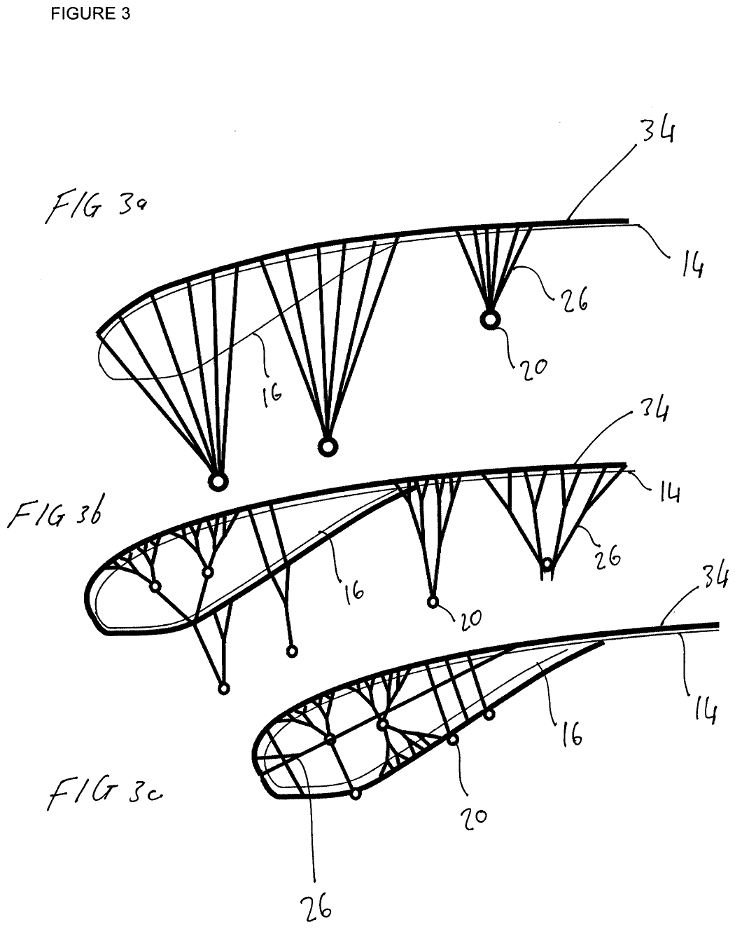

Referring now to FIGS. 3a, 3b and 3c showing several embodiments of rib bridles 26.

FIG. 3a depicts rib bridle 26 terminating at the upper sail (e.g. with a loop) and connect (e.g. with a loop or by other means) typically with the upper sail bridles (not shown).

The rib bridles 26 can also connect to a chord bridle 34, instead or in addition to one or more upper sail bridles.

The chord bridle 34 in turn can consist of a firm or semi firm, rigid, stiff material, to prevent collapsing of the upper sail or lower sail. The stiff chord bridle 34 can only span a portion of the chord of the kite 10, or spanning chord wise.

FIG. 3b shows rib bridles 26 terminating at the lower sail 16 and connecting with lower sail bridles 31 or lower bridles in the absence of a lower sail.

Further depicted are the various ways of how rib bridles 26 can split or furcate, prior to terminating at a sail or a sail bridle (upper sail bridle or lower sail bridle) or at a chord bridle. The furcation can be chord wise, as shown, or wing span wise (not shown).

FIG. 3c illustrates upper sail 14 and lower sail 16 having their own rib bridles, 26 which support the desired aerodynamic form between the two sails 14 and 16.

These rib bridles 26 can be singular or forked, with or without attachments points, extending upward and/or downward, or in-flight direction, or in any other direction, between sails 14 and 16.

Rib bridles 26 can be forked, with two or more furcations. The furcation can comprise of two or more forks and can be present in two or more sequential furcations, the one terminating in the other.

The objective of the furcation would be to distribute the load over a specified surface are of the canopy.

The rib bridles 26 can also connect with, instead or in addition, to one or more lower sail bridles or diagonal bridles (not shown).

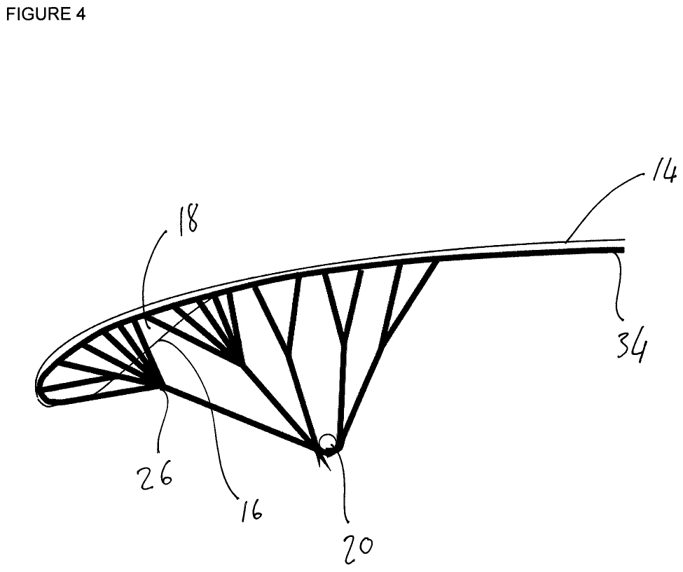

FIG. 4 is a schematic illustrating the rib bridles 26 consisting of multiple high-strength fibers originating from one attachment point 20, with one or several furcations, arranged sequentially or in parallel.

The rib bridles 26 can support a rib 18, which consists of a carrier fabric or carrier material, or in the absence of any fabric, as shown in this figure.

The rib bridles 26 efficiently disperse the load towards several further attachment points 20, into the ribs 18, or into the chord bridle 34, or towards upper sail bridles (not shown), or towards lower sail bridles (not shown), or into the upper sail 14 or lower sail 16 of kite 10.

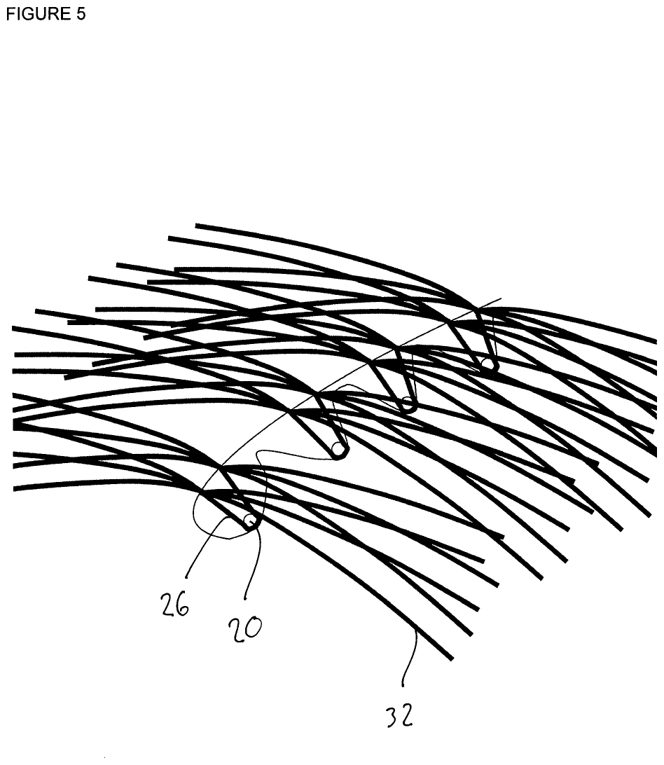

FIG. 5 depicts the rib bridles 26 and the upper sail bridles 32 arranged to manufacture two canopy cells. The rib bridles 26 and the upper sail bridles 32 can be manufactured out of one piece of material, or separately manufactured and connected to one another.

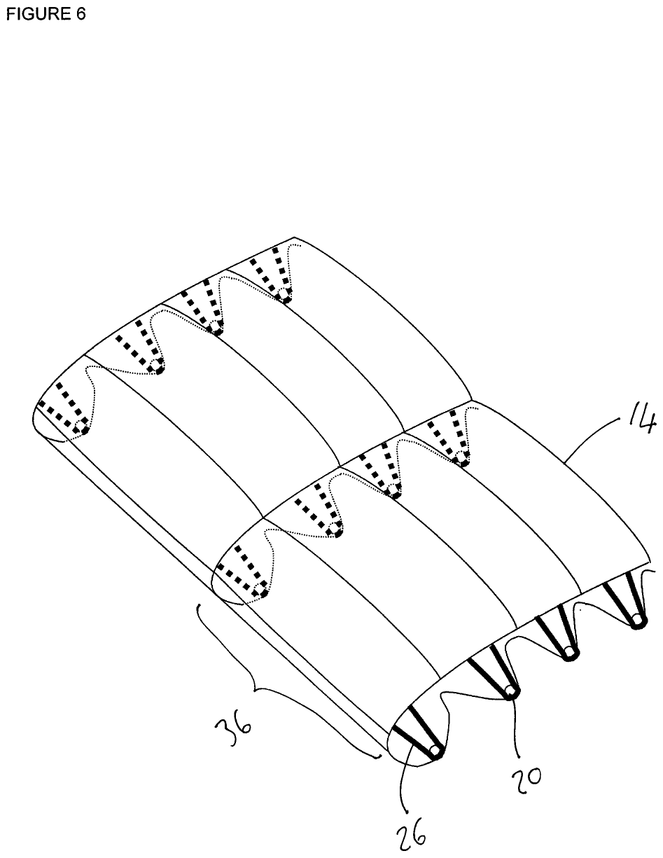

FIG. 6 to 9 are schematics illustrating the manufacturing of two canopy cells 36, according to the invention.

FIG. 6 shows an upper sail 14 extending across several cells 36, spanning over several ribs.

The rib bridles 26 extent along the direction of the rib (if present).

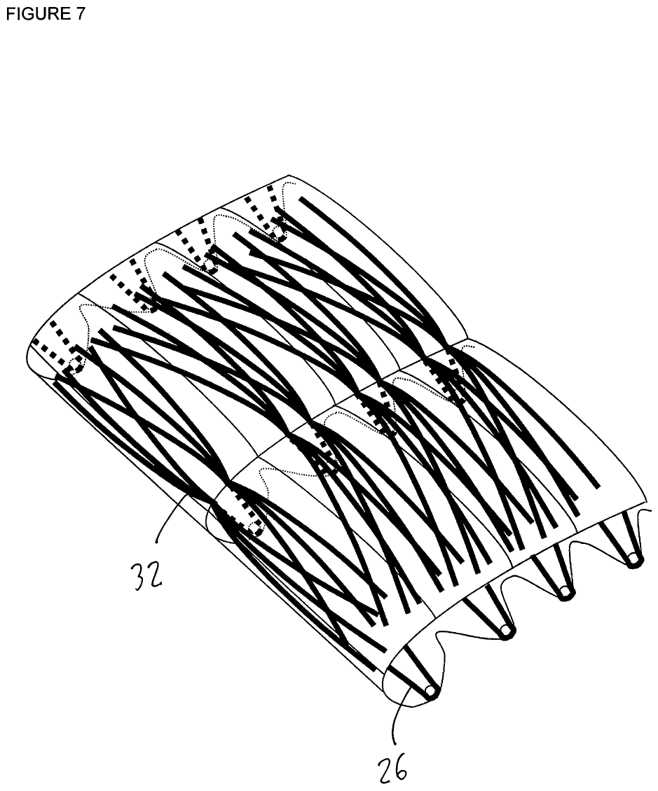

FIG. 7 shows the high strength fibers of the rib bridles 26 extending into the upper sail bridle 32.

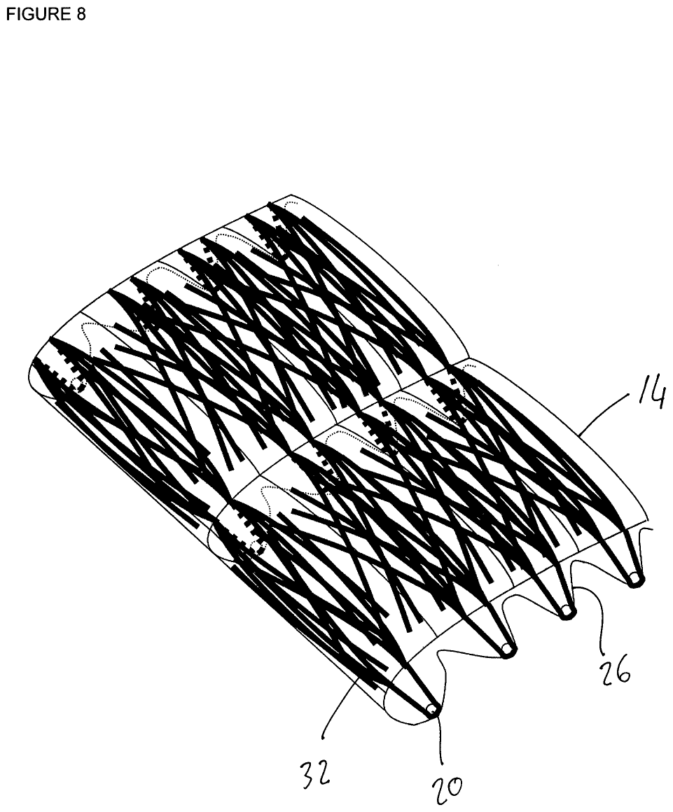

FIG. 8 shows further upper sail bridles 32 extending from further rib bridles 26 extending into the upper sail 14, in this case along the direction of the upper sail 14.

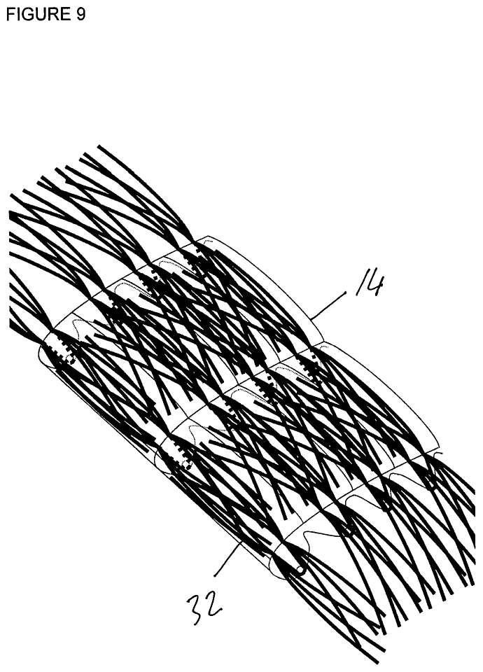

The upper sail bridles 32 can be entangled in a mesh, with high strength fibers or upper sail bridles extending from their attachment points of one rib, entangled (i.e. going over, being combined with, cross over, . . . ) with fibers extending from the attachment points of another rib as shown in FIG. 9.

FIG. 9 illustrates the addition of further upper sail bridles 32 added and extending into another section of the upper sail 14 (or another cell of the upper sail), along the direction of the upper sail. Any number of sections or canopy cells 36 can be added, one to another, in this manner, with the aim to build large RES kites (renewable energy source kites).

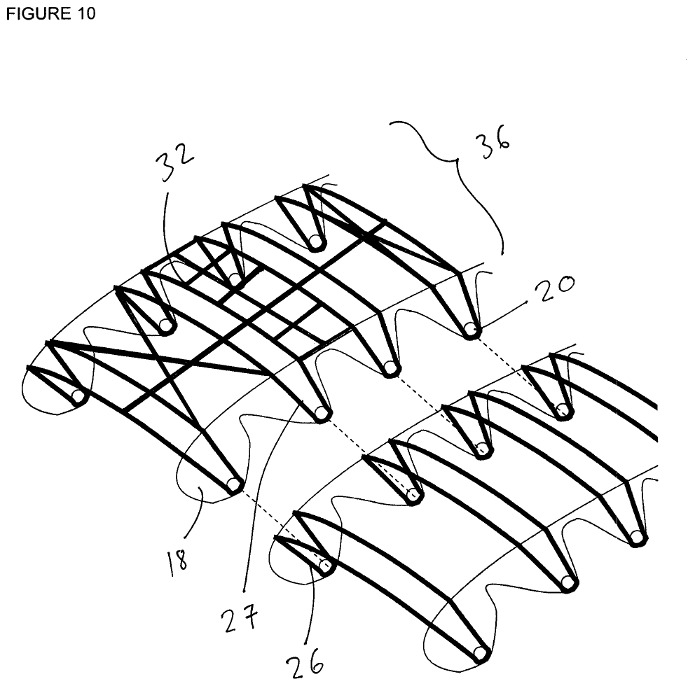

FIG. 10 is an explosive view illustrating a further embodiment of how to manufacture two canopy cells 36, according to the invention. Two cells 36 or sections of the upper sail 14, together with their ribs 18 (if present), are added one to another.

Each section or cell 36 has its own rib bridles 26, connected to upper sail bridles 32, which interconnect with another rib sail bridle 26 at another rib.

The network of rib bridles 26/upper sail bridles 32 forms a closed loop, from one attachment point 20 to another attachment point 20. The upper sail bridles 32 may be arranged in parallel.

Diagonal bridles 27 in turn lead from any point at the rib bridle 26 or any other bridle to the upper sail bridle 32 or any other bridle.

The upper sail bridles 32 (and the lower bridles or lower sail bridles, not shown for clarity reasons) may be arranged and/or combined in various forms.

Some embodiments are shown, such as extending across from one rib bridle 26 to another, substantially parallel to the wingspan axis, or diagonal, from one rib-bridle 26 to another, or in shoelace style.

Another embodiment can be in combination with chord bridles 34, which can be connected to rib bridles 26, and which can span over the entire chord of the sails, or only over a section of the chord (as shown), with the aim to prevent “ballooning” of the upper sail or lower sail. Lower-bridles (if present) or lower sail bridles (if present) may be arranged in a similar way as upper sail bridle 32

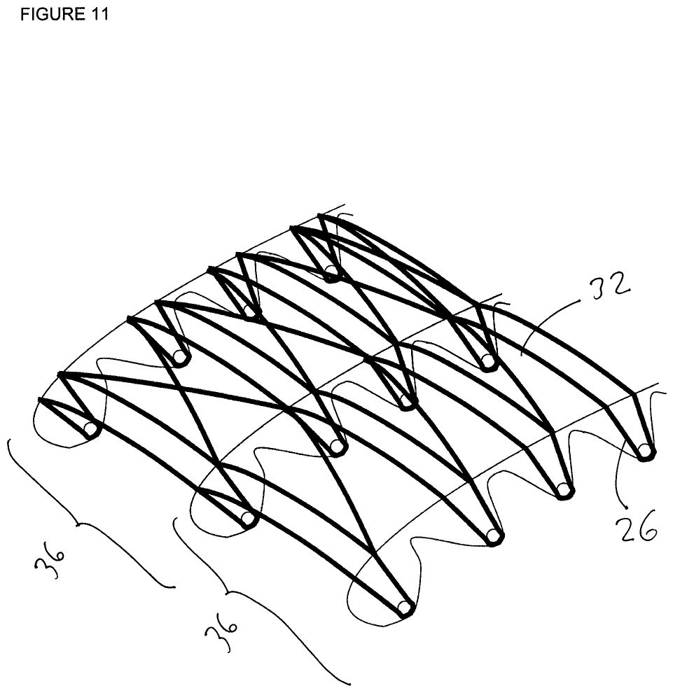

FIG. 11 is a schematic depicting yet another embodiment of how to arrange a system of rib bridles 26 and upper sail-bridles 32.

The rib bridle 26/upper sail bridle systems 32 can be formed in shoelace style, in addition or instead of the parallel style.

The cell 36 on the right illustrates an embodiment of a simple shoelace style arrangement (combined with parallel style) while the cell 36 on the left illustrates an embodiment of a double shoelace style arrangement.

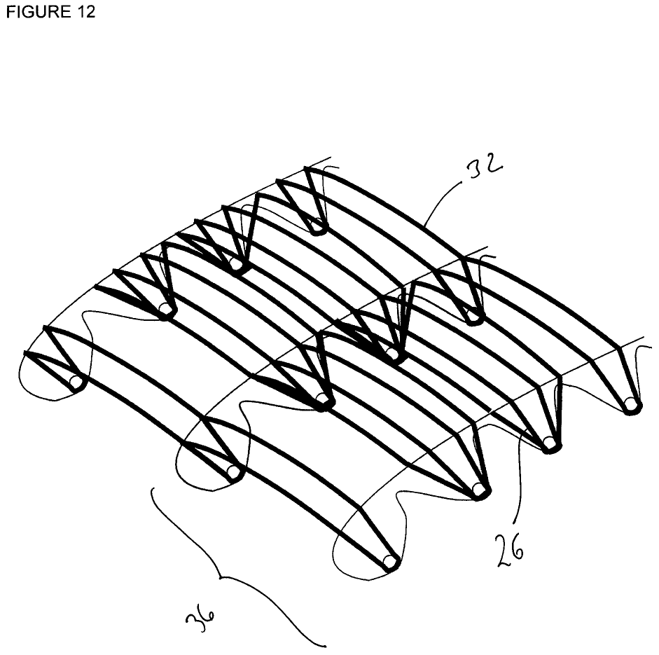

FIG. 12 is a schematic showing another embodiment of how to manufacture two canopy cells 36. The furcations of the rib bridles 26 can be multiplied, each connecting to one or more upper sail bridles 32 parallel to one another.

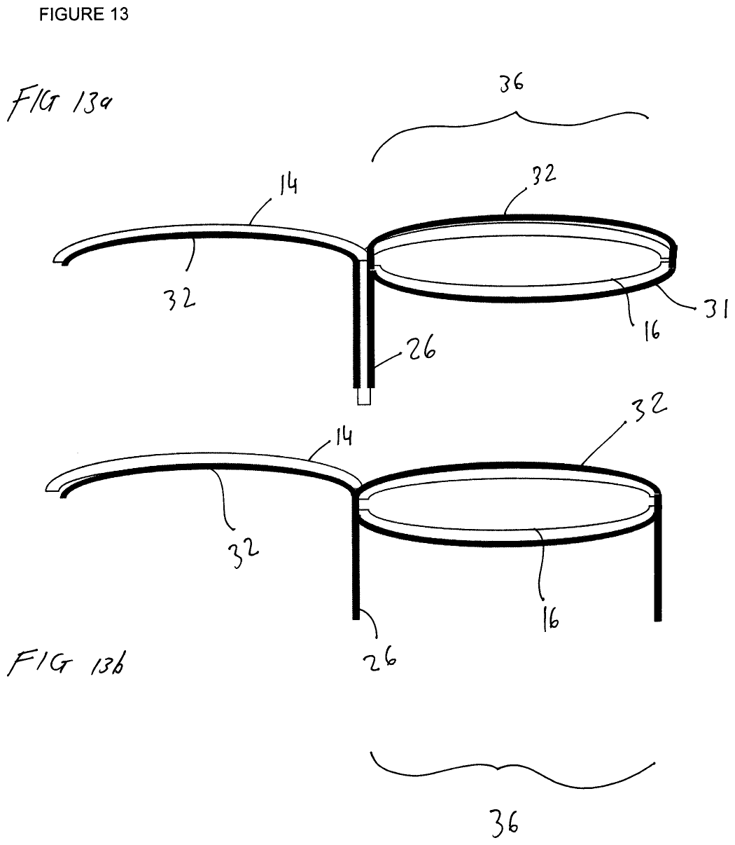

Turning now to FIGS. 13a and 13b depicting sectional view from a leading/trailing region of the kite 10.

The bridles or high strength fibers are arranged along the load lines of the compound textile fabric and attached to upper sail 14 and/or lower sail 16, by sewing, stitching, gluing, laminating or any other known joining method.

The fabric of sail 14 and/or 16 is mostly impermeable to air, to allow for pressure differences or gradients between the two sides of the fabric.

The high strength fibers or bridles have the main function to absorb the load, to hold the load, to distribute the load, and to induce the load into the upper sail fabric 14 or lower sail fabric 16, or into other bridles.

Depicted are upper sail bridles 32 and rib bridles 26, with the upper sail bridle 32 underneath the essentially impermeable fabric, shown on the left, and, shown on the right, an upper sail 14 and lower sail 16, with upper sail bridles 32 arranged on upper of the upper sail 14 and lower sail bridles 31 underneath the lower sail 16, both pressing against the bridles due to the dynamic ram air pressure, and lift of the upper sail 14.

In this embodiment the upper sail bridles 32 and/or lower sail bridles 31 function substantially as a corset to the sails 14 and 16.

The sail bridles can be fixated on the impermeable fabric, either a portion thereof or along its entire length, for instance by means of pockets which are stitched, glued, laminated, or the like, on the upper sail, or lower sail.

In FIG. 13a kite 10 have a pair of rib bridles 26 while in FIG. 13b one rib bridle 26 is employed forming a closed-loop system.

The upper sail bridle 32 can be continuous, spanning from one canopy cell 36 to another, as depicted in FIG. 13b. Knots or loops or slubs (thickenings) or splices or supporters at the upper sail bridle 32 at the connection point to the rib bridle 26 can be present to fix the connection point and prevent slipping or sliding or deformation of the connection (not shown).

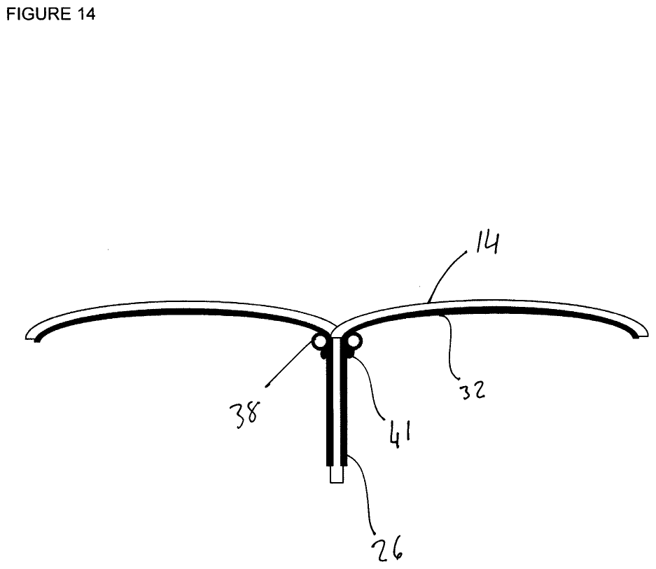

FIG. 14 is a schematic illustrating the support structures 38 of the high strength upper sail bridles 32 located at bend of the rib to the upper sail 14.

The supporting structures 38 can for instance be in form of rods, steel rods, or rods manufactured from synthetic materials connected to the bend to avoid that the bend will be pushed down and the upper sail 14 will separate from the upper sail bridle 32.

The rib bridle 26 can have a stopper 41 to avoid that the supporting structures 38 will be pushed down. The support 38 can be in the form of a beefed-up rib bridle 26, a bridle/fibre extending from upper sail 14 connected to the bend or any other solution to avoid that the bend will be pushed down and the upper sail will separate.

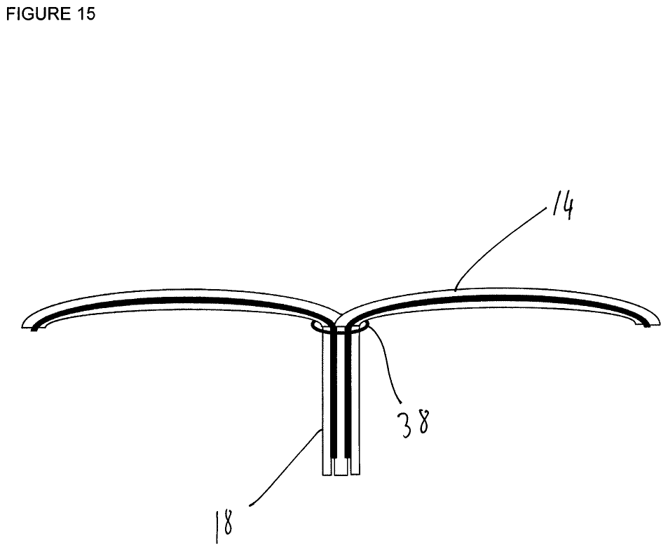

FIG. 15 is a schematic illustrating high strength fiber(s) arranged along the load paths inside a laminate structure, which in turn can be manufactured from textile or synthetic fabric, e.g. Polyester. The fibers can be sewed (stitched) or glued onto or inside the fabric layers.

The high strength fibers are further supported supporting structures 38 at the bend, e.g. from the rib 18 to the upper sail 14, the supporting structures taking the form of ring elements manufactured from synthetic materials, steel, or ropes.

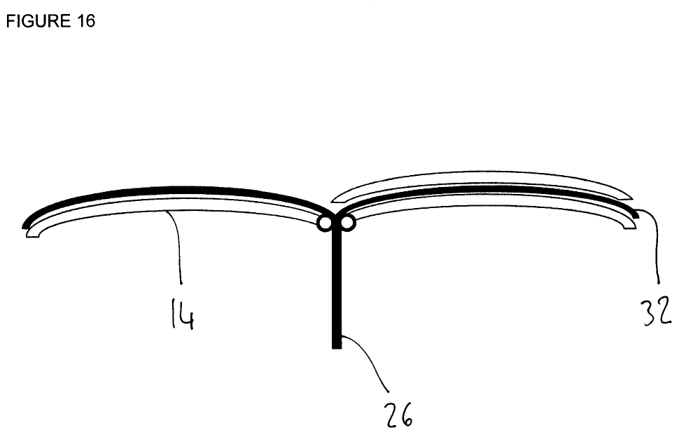

FIG. 16 illustrates the upper sail bridles 32 supporting the upper sail fabric from the upper, with the fabric 14 pressing against it by the lift, as shown on the left-hand side, or, can be laminated, sewed, glued or by any other connection into two or more layers of upper sail fabric 14, as depicted on the right-hand side.

If there are two or more layers of upper sail fabric comprising the upper sail 14, these additional layers can cover the entire primary upper sail 14, or only parts of it, and therefore the upper sail bridles there, fully or partly.

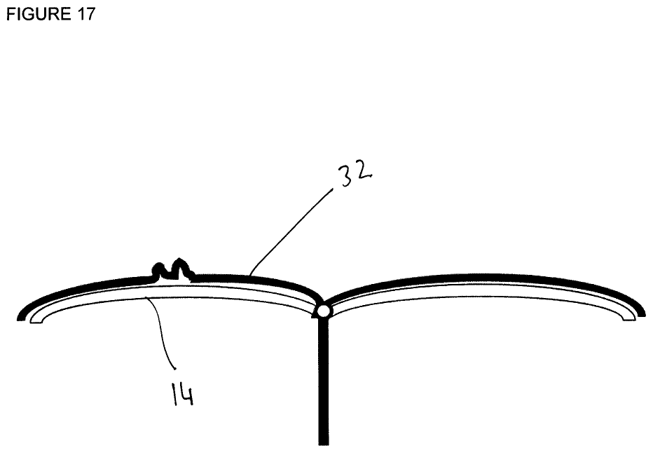

FIG. 17 is a further schematic illustrating the upper sail bridles 32 exceeding the length dimension, wingspan wise, as shown, and/or chord wise, for instance 3% longer or more (as shown on the left), to allow for the upper sail fabric to expand under load (shown on the right).

The purpose of which is to have the upper sail as aerodynamically optimally dispersed under full working load.

The same principle can essentially be applied for the lower-sail (not shown).

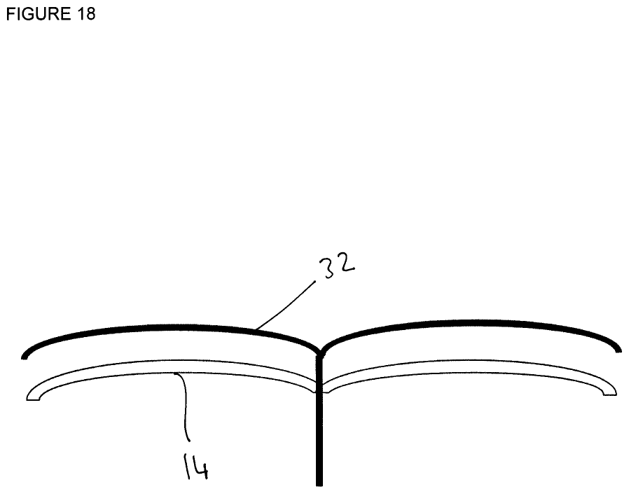

FIG. 18 is a schematic showing the upper sail bridles 32 detachably arranged relative upper sail 14. In this embodiment the function of the upper sail 14 is essentially to divide air masses, by being mostly impermeable to air, and to allow for pressure differences between these bodies of air. The upper sail 14 membrane (or fabric or textile) can be detached, removed, changed or renewed, while retaining the bridle structure. The bridle's main function would essentially be to absorb and hold the load.

The upper sail and lower sail and the various bridles can have different durability. By incorporating the interchangeable feature if the upper sail is damaged by exposure to UV light, or which gets weak or ages faster through constant load changes during flight, it can be renewed, while retaining the bridle structures resulting in cost efficiency, cyclical re-usage, and/or a simpler manufacturing process.

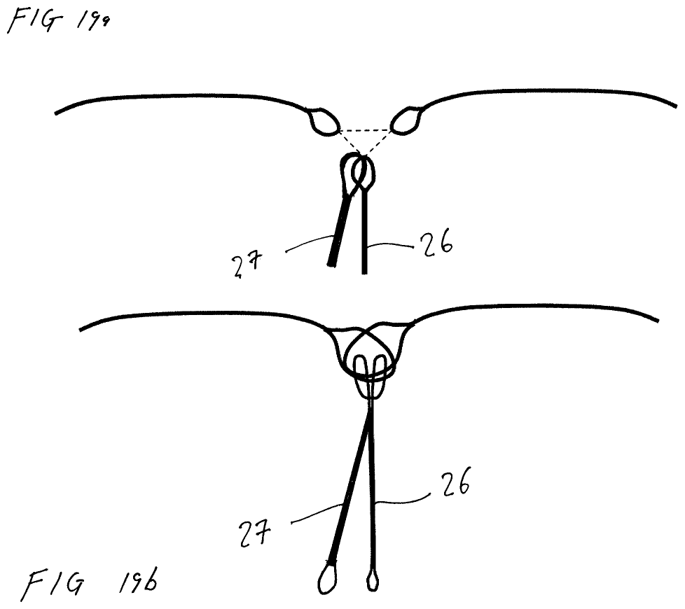

FIG. 19 a is an exploded view and FIG. 19 b a sectional view depicting the connection of a rib bridle 26 and a diagonal bridle 27 to two upper sail bridles (or lower sail bridles or chord bridles.

All bridles terminate in loops, which loops are defined by stitching or by splicing, or by any other known means, and which can be interconnected to one another. The interconnection of the bridles can be in form of knots, interlocks or by any other suitable means.

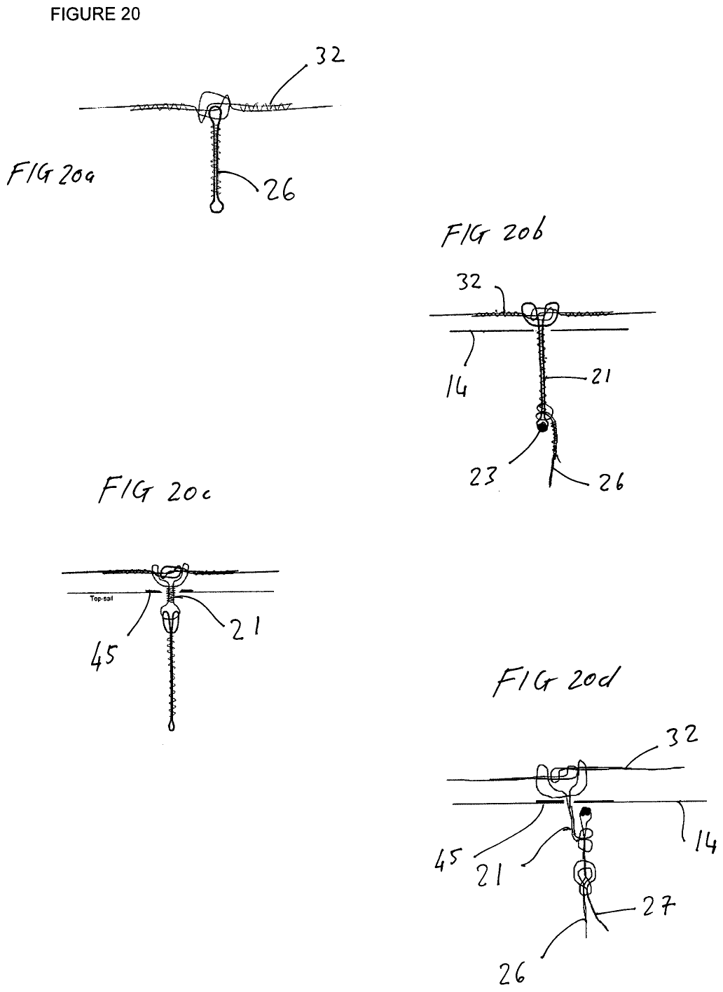

FIGS. 20a, 20b, 20c and 20d illustrates various means and examples of combining rib bridles 26 and upper sail bridles 32, and other bridles, either in an open loop or in a closed-loop configuration.

In FIG. 20a the upper sail bridles 32 are interlocked and the rib bridle 26 loops around one upper sail-bridle-loop. This configuration can both absorb vertical loads in vertical directions, and shear loads in horizontal directions.

In FIG. 20b the upper sail bridles are interlocked and the rib-bridle connector line 21 loops over both upper sail bridles. A rib bridle connector 21 from upper sail bridle 32 and optional a chord bridle (not shown) end with a possibility to detach the connection to one or more rib bridles 26 or a diagonal bridle (not shown).

That can be done by beefing up the end of the connector line or rib bridle with a knot 23 or any other known connection form, so that the attached line(s) will be locked during use and can be detached to replace the upper sail 14 and later a new upper sail can be re-attached.

In FIG. 20c, with a short first rib-bridle connector 21, terminating in a loop, to which a second rib bridle can be connected, with the aim to fix and to enable a removable upper sail manufactured with pinholes, through which the short first rib-bridle is led. The pinholes in the upper sail may be seamed or reinforced 45 to prevent tearing and to seal the whole against air passing through.

FIG. 20d shows another embodiment how to connect rib bridle connectors 21 with rib bridles 26, terminating in a knot.

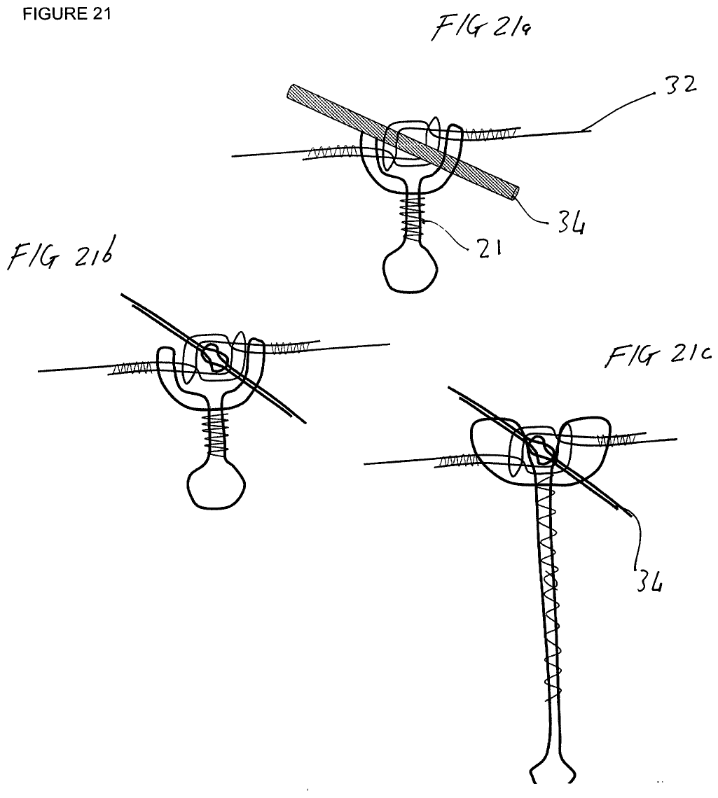

FIGS. 21a, 21b and 21c illustrates various means of combining rib bridles 26 with chord bridles 34 and upper sail bridles 32. The system can be in an open or closed-loop architecture.

FIG. 21a shows the two upper sail bridles 32 first loop around the (stiff or rope-type) chord bridle 34, interlocked with each other. Thereafter the rib bridle 26 loops and interlocks with the upper sail bridles 32, or with the chord-bridle 34, or both. This forms a stable knot for all four bridles.

FIGS. 21b and 21c show the chord-bridle consists of two ropes (high strength fiber ropes), interlocked with one another. The upper sail bridles 32 interlock over the chord bridle 34 (or vice versa) and the rib bridle 26 then loop over the upper sails bridle, interlocked (b), or over the chord bridle (not shown) or both (c), defining a stable knot for all involved bridles and absorbing shear forces, as well as the lift forces of the kite.

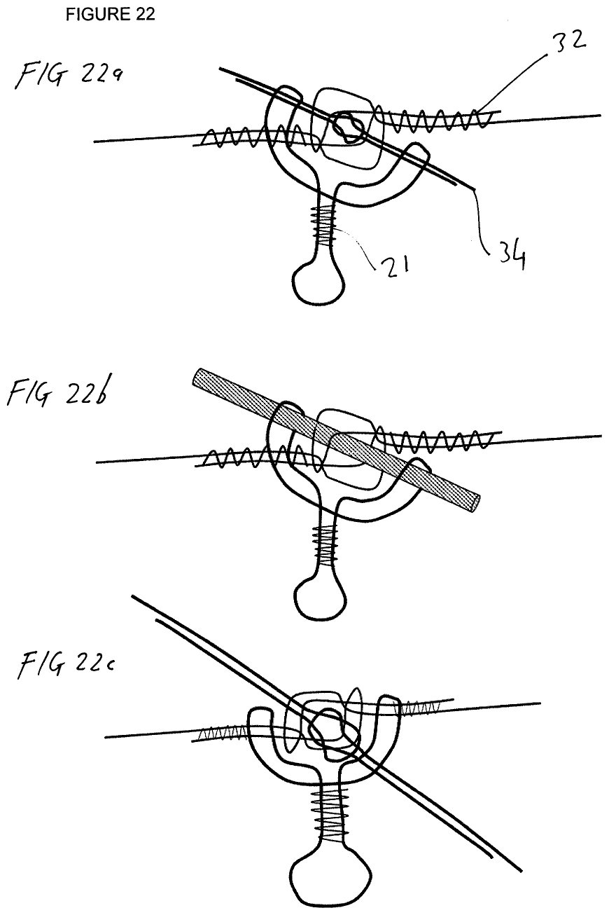

FIGS. 22a, 22b and 22c illustrates a further configuration of combining rib bridles 21 with chord bridles 34 and upper sail bridles 32. The rib bridle first loops around the chord-bridle, and then the two upper sail bridles interlock over the first loop, around the chord bridle and rib-bridle. This forms a stable knot for all four bridles, which can absorb forces downwards and in all sideward/forwards/backward directions.

In FIGS. 22b the chord bridle consists of a stiff material, e.g. a light weight and high-strength rod. It has to be noted, if the kite is manufactured with stiff chord-bridles, along its entire chord or along only section of the chord (with the remaining section having e.g. rope-type chord-bridles), that the kite can still be folded or rolled, over its chords. This has advantage in the usage of the kite, for instance over a hard kite, built substantially out of stiff materials.

FIG. 22c is similar to FIG. 22a but for the rib-bridles looping around the lower portion of the upper sail-bridle interlock.

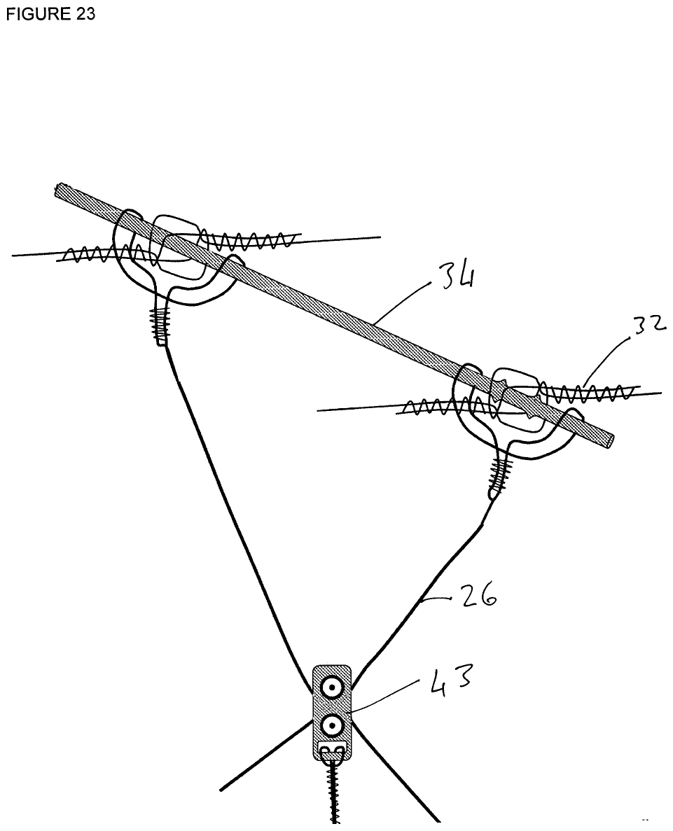

FIG. 23 shows the various means of combining rib-bridles 26 with chord-bridles 34 and upper sail bridles 32. Two or more upper sail bridles loop over a chord-bridle 34. The chord-bridle 34 can be manufactured from a stiff or semi-stiff or flexible material, as shown, or manufactured out of a high strength fiber, either continuous, or looped, where it meets the rib-bridle and/or upper sail bridle. The rib-bridle first loops around the chord bridle. The rib-bridle is then guided for instance around a ring (not shown) or a pully 43 towards another attachment point of the chord-bridle.

The rib bridle 26 forms a closed-loop configuration and is manufactured out of one piece, but can also be forked towards the upper sail (not shown). The rib-bridle coming from the intermediate bridle can also run over a pulley 43 as shown.

This has the effect that the attachment point at the upper sail can adapt, while changing angle of attack of the wing to increase the smoothness of movement of the upper sail in the wind stream.

Further bridles or a main kite connecting line can attach to the pully or the ring. Further bridles can attach downwards, either with a fixed connection or moving over a pully.

If the chord-bridle is manufactured from a stiff material, e.g. plastic, it can have a groove, a nib and/or a catch 42 (as shown at the right hand side), to prevent the upper sail-bridle and/or rib-bridle from moving along the chord bridle, with the aim to be able to absorb also shear forces, next to forces directed substantially at an inclined angle to the upper sail (e.g. downward or side downward loads).

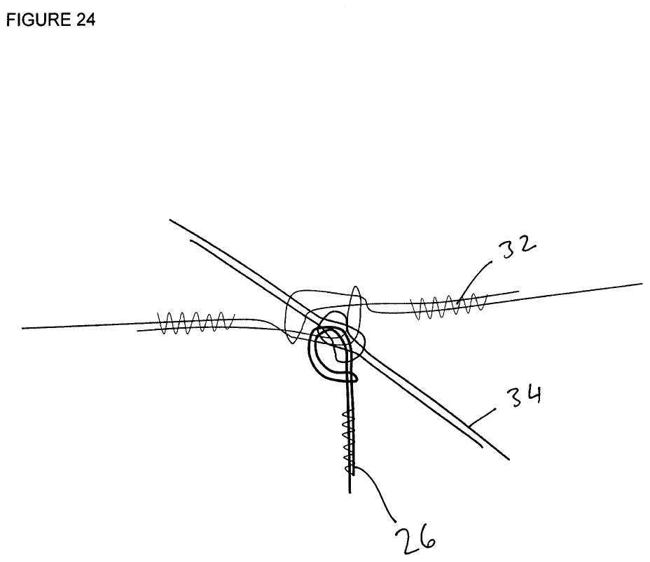

FIG. 24 shows a further configuration to combine rib-bridles with chord-bridles and upper sail bridles, all ending in a loop.

The loop end portions of two or more upper sail bridles 32 can be connected by interlocking together. The chord-bridle 34 consist of interlocking segments, terminating in loops. The interlock goes through the interlocking loop of the upper sail bridles, to form a firm connection, which cannot move. The loop end portion of a rib-bridle 26 is guided with a larks-head knot both through the interlock of the chord-bridles, through both eyes, and the interlocking loop of the upper sail bridles.

With this, all bridles segments, in this case at least five bridle segments, form a firm connection, which cannot move and which can absorb loads and forces in all directions.

Alternatively, the interlocking loops can be in the form of loops with larks-head knots.

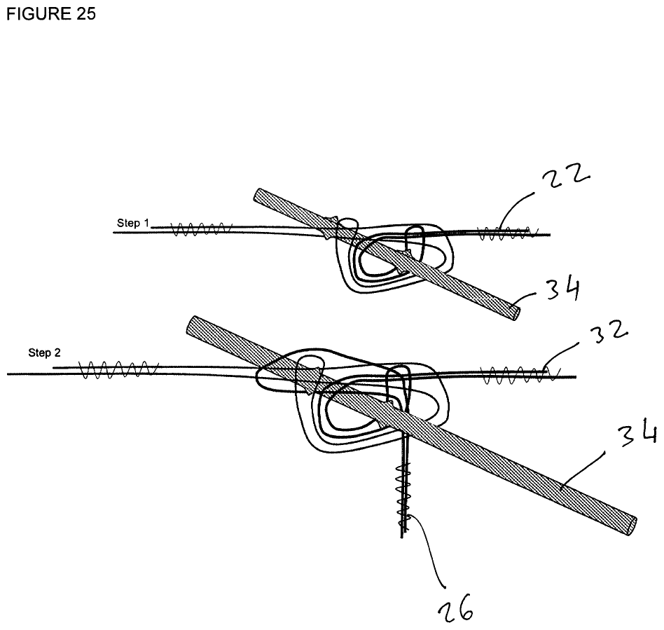

FIG. 25 depicts a further configuration to connect rib bridles 26 to chord-bridles 34 and upper sail bridles 32, all terminating in a loop (not shown).

The two segments of upper sail bridles go with a larks-head knot over the chord-bridle, which can consist of two interloped segments (not shown) or one segment. The chord-bridle can be a stiff rod, as shown.

The larks head knots of the upper sail bridles go over each other to form a firm connection, which cannot move. This lock can be over or under the chord-bridle interlock.

The rib bridle then loops around the chord-bridle, loops around one upper sail-bridle and goes through the loop of the other upper sail-bridle. This forms a stable connection for all five bridles (or four bridles, if the chord-bridle is made out of one stiff rod, or if it is a continuous rope).

The order to do the above can be varied, which essentially forms multiple embodiments of the invention.

These specific ways to combine the various bridles result in an effective uptake of lateral forces, along the extension direction of the bridles, next to an effective uptake of the load forces caused by the lift of the kite, which are substantially non-tangential to the upper sail, up to an orthogonal direction of the uppers-sail, and which are ultimately transported down to the ground station of the kite, along the traction rope(s) in form of traction forces.

The upper sail bridles 32 can also be continuous like shown for the chord bridles 34. The upper sail bridles 32 can have slubs or knots or splices or loops or lugs or connecting links present, to prevent the connection from slipping or moving away from the intended connection point, and to absorb sheer forces, same as shown for the chord-bridle 34.

The chord-bridles 34 can have slubs or knots or splices or loops or lugs or connecting links present, to prevent the connection from slipping or moving away from the intended connection point, and to absorb sheer forces as shown.

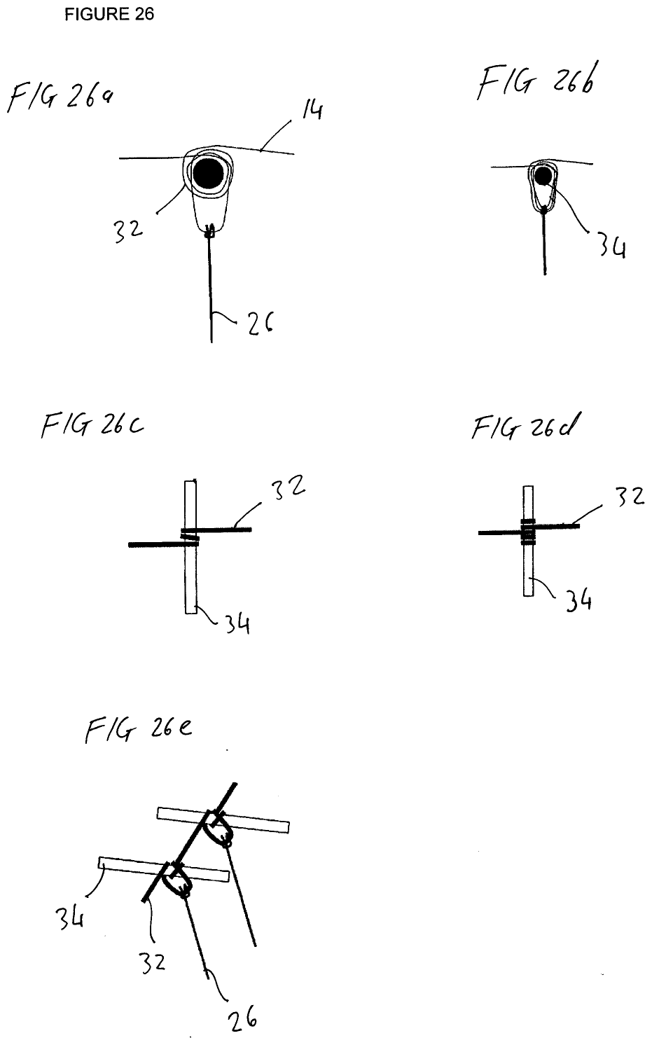

Turning now to FIGS. 26a, 26b, 26c, 26d and 26e. The upper sail 14 can be a laminated structure, with the upper sail bridles 32 between the laminate layers. The upper sail bridles can be manufactured out of round-shaped, oval-shaped, or flat-shaped high-strength fibers. The chord bridles 34 can consist out of a firm or stiff material, which allows to absorb forces in all directions, and around which the upper sail bridles are tied, forming a loop, which extends below the lower laminate layer.

To this loop a rib bridle 26 can be attached. The connection can absorb forces in downwards, forwards, and sideward directions.

In this configuration the area of the upper sail can have a number of loops at its downward facing surface positioned along the chord-bridles, to which a multitude of rib-bridles can be attached for absorbing high loads.

FIG. 26a: Front view, in flying direction. An upper sail bridle tied around a chord bridle. A rib-bridle attaches to the loop.

FIG. 26b: Same as 26a, but the upper sail-bridle forms several loops at the underside of the upper sail. The same can be done at the lower-sail. The loop can instead or in addition be formed from a separate line or rope (not shown).

FIGS. 26c and 26d: Upper view. Various examples of an upper sail bridle tied around a chord-bridle.

FIG. 26e: Lower perspective view of the upper sail. The upper sail itself is omitted, for clarity reasons, shown are the upper sail bridles, tied around the stiff chord-bridles, with a loop, to which rib-bridles attach. An alternative can apply the embodiment of FIG. 22b.

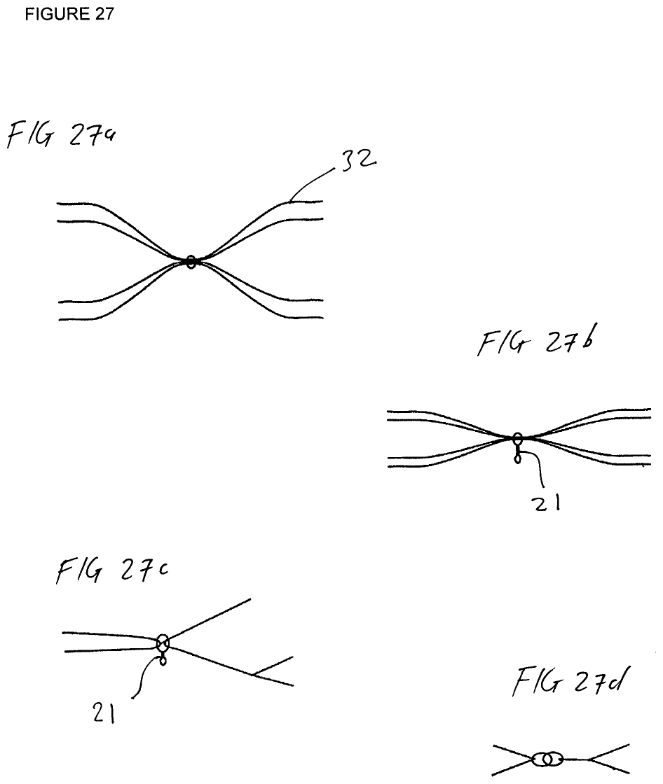

FIG. 27 depicts yet a further embodiment with the upper sail as a laminated structure, with the upper sail bridles 32 in round, oval or flat shapes laminated between two or more upper sail layers. In contrast to the previous embodiment, this configuration does not necessarily require stiff chord bridles, or chord bridles consisting out of fiber ropes.

Instead or in addition, two or more upper sail bridles converge at the point, where the loops are attached, able to absorb forces in downward direction, and in horizontal directions (shear forces, tangential to the laminate). The loops, where the rib bridle 21 can be attached, extend below the lower laminate layer and look out at the lower.

FIG. 27a is an upper view showing upper sail bridles converge and a portion of the rib-bridle 21 loops around them, to form an attachment point. The upper sail itself is not shown, for clarity reasons.

FIG. 27b is a perspective view showing the rib-bridle extending downwards from the attachment point (in this instance a short rib-bridle 21, to which an extension rib-bridle can be attached). Rib-bridles can be knotted around the loop, and rib-bridles ending with a slub or knot, can be attached to this loop, e.g. with a larks-head knot (not shown) or with other knots. The slub or knot can also be at the upper end of the rib bridle 21.

In case the upper sail bridles are continuous, there may be slubs or knots or splices or loops or lugs or connecting links present, to prevent the connection from slipping or moving away from the intended connection point, and to absorb sheer forces.

FIG. 27c is a perspective view of yet a further embodiment how to combine the short or long rib-bridles with the upper sail bridles, which can be laminated into the upper sail. Upper sail bridles loop around a loop or a ring of the rib-bridle, with the aim to absorb or induce sheer forces (in horizontal directions), while preventing movement of the connection point. These can be combined with upper sail bridles as described in FIGS. 27a and 27b.

FIG. 27d: Another embodiment how to combine upper sail bridles 32, ending in loops, and to which a rib-bridle can be attached.

Chord-bridles, either in form of high-strength flexible fibers or in form of stiff material can be added.

The same can be done at the lower-sail.

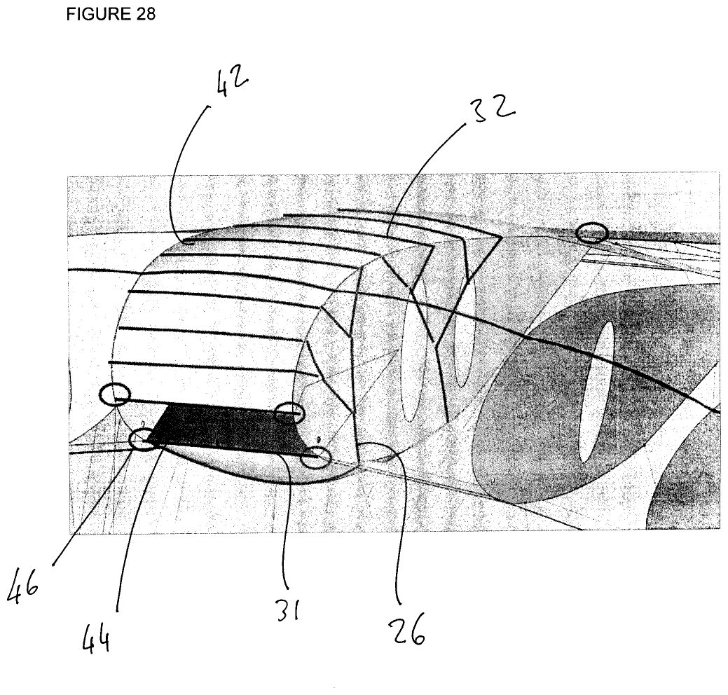

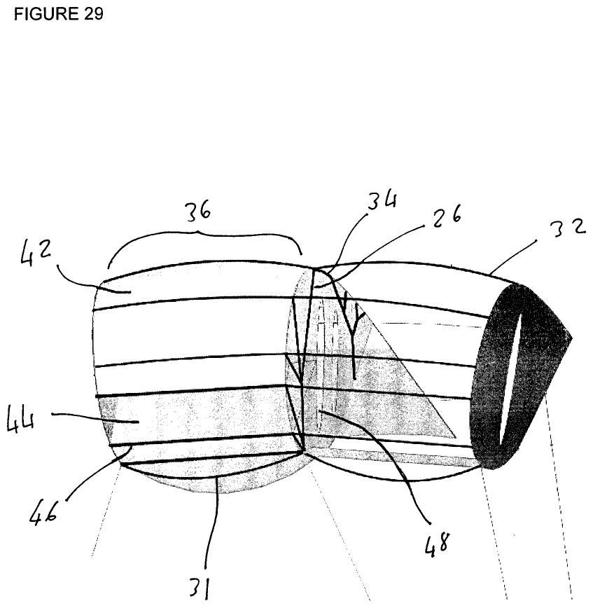

FIGS. 28 and 29 show yet a further embodiment of the kite in accordance with the invention wherein a pressure bag 42 is encased with upper sail bridles 32 and lower sail bridles 31, suspended by rib-bridles 26. The pressure bag 42 has an air intake opening 44 facing incoming air flow, in use.

The pressure bag 42 has at the front an opening 44 or a valve. The valve is fixated at one or more points at the upper/lower sail bridles and/or rib-bridles at the leading edge, either by fixation points 46 or by other means. The opening or valve can be supported by stiff elements so that the bag can be filled by dynamic ram air pressure. It can in addition be fixed at more points, also at the chord-bridles, preferably at the trailing edge of the cell.

The pressure bag can easily be replaced, by detaching it from its fixing points, and attaching a new pressure bag at these fixing points.

This embodiment can be combined with a detachable/removable upper sail as per FIGS. 18 and 20b-d. In this case, the upper sail bridles are connected to short first rib-bridle connectors, to which a second (or third) rib-bridle can be connected.

The upper sail, equipped with pin-holes, through which the short rib-bridles are guided, and which substantially fix the removable upper sail, is arranged above the pressure bags, which inflate and which are supported by the bridle structure and press against it, to give form to each and every cell.

Both, pressure bag and upper sail, can be removed and replaced, with the aim to recycle the bridles corset, which can include any one or more of the group of rib-bridles, short rib-bridles, upper sail bridles, lower-sail bridles, diagonal-bridles, and chord-bridles. All bridles can be forked and can have pullies or rings, to arrange their connections in a “swimming” manner.

Alternatively, the pressure bags can be pre-pumped (with no air intake), instead of inflation by ram air pressure.

The pressure bag may be filled with air or alternatively with a gas lighter than air.

The pressure bag and the air intake, which may take the form of a valve, can be fixed at the bridle/upper sail or lower-sail structure or just be loosely placed inside the bridle and/or upper-/lower-sail corset.

Pressure bags can have connections to other pressure bags 48 at other cells 36 to let air pass through to other pressure bags.

The pressure bags can be also disconnected from bridles that need to pass though the pressure bag like diagonal-bridles and lower (sail) bridles.

### Advantages of the Invention

A lightweight kite comprising a light weight upper and/or lower sail material having a relatively large surface area, structurally supported by a network of bridled lines to effectively support and reinforcing the one or more sails and which can handle maximum loads (for maximum energy output: mechanic, electric and/or in hydrogen).

The kites are light enough to go airborne in wind speeds as low as 6 knots, the light weight further defining an optimized load/weight ratio, minimized drag and maximized performance.

Prefilled with gas lighter than air the kite can stay airborne, which can avoid complicated starting and landing procedures.

The lightweight, high-load kite will typically be suitable for harvesting wind energy in the renewable energy sector.

The invention leads to kites, which can tolerate highest loads, while being relatively light, and/or having minimum drag, and/or showing highest performance, and/or creating highest lift, and/or being most durable, and/or allow for a highly cost-efficient production, and/or allow for recycling of a portion of its structure, and/or allow for highly ecological production and/or operation.

Further, the invention allows for kites, which can be de-powered, for instance to maximize high-power-flight or to be of use in a JoJo-system (kite pumping cycle system) and protects the system from getting overpower and increases its safety.

Further, the invention leads to kites, which allow to maximize traction and/or minimize the cost per kW in energy production (mechanical, electric, or in gas or fuel), so-called RES kites.

One of the objects of the invention is to have a kite having a large surface area, wherein the connection points between the one or more sails and the one or more kite lines are spread in such a manner that the kite can endure high loads.

The forces are distributed/spread by means of kite line attachment points, first into the intermediate bridle network (also called extension or suspension bridles; possibly containing optional mixers and/or a bow bridle), and then into a subsequent bridle structure, and from there towards the canopy (consisting out of an upper sail, and/or upper sail bridles, and/or chord-bridles; and/or lower bridles; and/or diagonal bridles; and potentially a lower-sail; and in this case with or without lower sail bridles), which is substantially non-tangential, preferably with an inclined angle of 30-90 degrees relative the ribs or rib-bridles.

Another object of the invention is to replace the classic rib of a kite with a rib bridle structure; and then induce the main load into the rib bridle, and from there via upper sail bridles into the upper sail.

The technical advantage of rib bridles being arranged at an inclined angle relative the upper sail, and also having the rib bridles and upper sail bridles being arranged at an inclined angle relative one another, and rib bridles and lower sail bridles being arranged at an inclined angle relative one another is
to absorb the load from the upper sail and lower sail (if present) in the direction of the traction ropes more efficiently;
to gain a higher projected surface, in the direction of the traction ropes, and therefore a flatter kite, with more power per square meter of the kite;
to define a highly load resisting, highly efficient airfoil shape at the canopy;
to increase the lift-to-drag ratio to increase the power output of the kite;
to gain an increase in stability of the kite, made out of flexible or semi-flexible (non-rigid) materials;
and therefore to increase controllability of the non-rigid kite.

The technical advantage of diagonal bridles is to efficiently absorb diagonal forces and therefore to reduce the amount of intermediate bridles, and with this to reduce drag by the intermediate bridles, with the effect to increase the power of the kite.

The Applicant considers the invention advantageous in that the inclined angle arrangement of the rib bridles relative the upper sail, upper sail bridles and lower sail bridles yields a kite with a more efficient load distribution from the top sail and bottom sail (if present) in the direction of the traction ropes. Also, the inclined angle relationship results in an increased projected surface area, in the direction of the traction ropes, and therefore a flatter kite, with more power per square meter of the kite. Further the non-tangential arrangement also defines a load resisting high efficient airfoil shape at the canopy and importantly, with an increase of the lift to drag ratio to thereby resulting in an increase in the power output of the kite.

The inclined angle arrangement between the structures also have been found to result in an increase in stability of the kite, which kite is typically manufactured from flexible or semi-flexible materials (non-rigid), therefore an increased controllability of the non-rigid kite.

It is to be appreciated that the kite in accordance with the invention is not limited to the precise constructional and functional details as hereinbefore described with reference to the accompanying drawings and can be varied as desired.

1-54. (canceled)

55. A kite which includes:
a canopy (12) comprising:
an upper sail (14); and
a plurality of rib bridles (26) arranged substantially at an inclined angle relative the upper sail (14);
wherein the rib bridles (26) are further connectable to upper sail bridles (32), which upper sail bridles (32) extend at an inclined angle away from the rib bridles (26) with the upper sail bridles (32) being arranged substantially parallel to the upper sail (14).

56. A kite as claimed in claim 55 wherein the plurality of rib bridles (26) are arranged in an interconnected relationship with one another.

57. A kite as claimed in claim 55 wherein the upper sail bridles (32) extend from a rib bridle (26) at one chord toward a rib bridle (26) at another chord.

58. A kite as claimed in claim 55 wherein span-wise wingspan of the canopy (12) divided by chord length yields a ratio of at least 2.

59. A kite as claimed in claim 55 having a minimum of 5 ribs.

60. A kite as claimed in claim 55 having a minimum of 5 cells.

61. A kite as claimed in claim 55 wherein the majority of the upper sail bridles (32) has a breaking strength index exceeding that of the rib bridles (26).

62. A kite as claimed in claim 55 wherein a major portion of the rib bridles (26) are connected to upper sail bridles (32), with the upper sail bridles (32) extending in a substantially inclined angled direction away from the rib bridles (26).

63. A kite as claimed in claim 55 wherein the rib bridles (26) and upper sail bridles (32), when operated in conjunction with one another, include a means for varying the angle of attack of the kite.

64. A kite as claimed in claim 55 wherein at least one kite connecting line (24) is indirectly connected to at least one rib-bridle (26) via a mixer.

65. A kite as claimed in claim 55 wherein at least one kite connecting line (24) is indirectly connected to at least one rib bridle (26) via a gondola.

66. A kite as claimed in claim 55 wherein the rib bridles (26) terminate at the upper sail bridles (32), the upper sail bridles (32) further extending wing span wise towards other ribs (18) and/or rib bridles (26) into opposing directions.

67. A kite as claimed in claim 55 wherein upper sail bridles (32) terminate in a split and/or furcated formation.

68. A kite as claimed in claim 55 wherein the upper sail bridles (32) extend from a rib bridle (26) at one chord to a rib bridle (26) at another chord non-parallel relative an axis defined between wing tips of the kite, in a so-called shoe lace style.

69. A kite as claimed in claim 55 wherein at least one kite connecting line (24) and intermediate bridle network (22) are attached to the rib bridles (26) via additional pulleys, a mixer, or similar hoists.

70. A kite as claimed in claim 55 wherein the rib bridles (26) are connected to chord bridles (34) which chord bridles (34) extend at a substantial inclined angle away from the rib bridles (26) and in a substantial inclined angle direction away from the upper sail bridles (32).

71. A kite as claimed in claim 55 wherein the canopy (12) is free flying, without any connection to a ground station, with the at least one kite connecting line (24) connected to a load, instead.

72. A kite as claimed in claim 71 wherein the load includes any resistance and/or weight element such as a spacecraft, a packet, an airplane, or the like.

73. A kite as claimed in claim 55 wherein the canopy (12) includes one or more lower sails (16), with the upper sail (14) at least partially overlay the one or more lower sails (16) and where the rib bridles (26) are connected to lower sail bridles (31), which lower sail bridles (31) extend substantially at an inclined angle direction away from the rib bridles (26).

74. A kite as claimed in claim 55 wherein the rib bridles (26) take the form of diagonal bridles (27) interconnected to the upper sail bridles (32) and/or the chord bridles (34) at an angle of between about 35 and 55 degrees.

75. A kite as claimed in claim 55 wherein the length dimension of a major portion of the upper sail bridles (32), measured between chords, exceeds the length aspect of the upper sail (14) measured between the said chords

76. A kite as claimed in claim 55 wherein the upper sail (14) includes pinholes, through which rib bridles (26) connectors are guided, each connecting with at least one upper sail bridle (32).

77. A kite as claimed in claim 55 wherein pressure bags are located in between the bridle structures.

78. A kite as claimed in claim 77 wherein the pressure bags are filled with a gas having a density less than air.
